(19) United States
(12) Patent Application Publication
(10) Pub. No.: US 2022/0392123 A1
(43) Pub. Date: Dec. 8, 2022

(54) IMAGE COMPOSITION WITH MULTIPLE BLEND MODES

(71) Applicant: Apple Inc., Cupertino, CA (US)

(72) Inventors: William J. THIMBLEBY, Sunnyvale, CA (US); Peder BLEKKEN, Morgan Hill, CA (US)

(21) Appl. No.: 17/737,919

(22) Filed: May 5, 2022

Related U.S. Application Data
(60) Provisional application No. 63/197,487, filed on Jun. 6, 2021.

(51) Int. Cl. G06T 11/20; G06T 11/40; G06V 30/32

(52) U.S. Cl. CPC G06T 11/203; G06T 11/40; G06V 30/347

(57) ABSTRACT

A method includes receiving a plurality of strokes for compositing on a content item and composing each stroke of the plurality of strokes into a respective stroke layer based on a blend mode associated with the respective stroke. The method further includes compositing the stroke layers composed from the plurality of strokes into a single layer and compositing the single layer on the content item.

### CROSS REFERENCE TO RELATED APPLICATIONS

This application claims the benefit of priority to U.S. Provisional Patent Application No. 63/197,487, entitled, “Image Composition With Multiple Blend Modes”, filed on Jun. 6, 2021, the disclosure of which is hereby incorporated herein in its entirety.

### TECHNICAL FIELD

The subject application relates generally to image processing, including multi-layer image composition.

### BACKGROUND

Applications provide a number of ways to modify content items such as web pages, documents, images, etc. For example, implements such as a stylus or a user's finger may be used to enter hand-drawn strokes modifying the appearance of a content item. A particular tool such as a marker or pen may be selected to be represented by the stylus or finger. The selected tool may have a specified behavior or blend mode to be applied when a stroke is composited on the underlying content item.

### BRIEF DESCRIPTION OF THE DRAWINGS

Certain features of the subject technology are set forth in the appended claims. However, for purpose of explanation, several embodiments of the subject technology are set forth in the following figures.

FIG. 1 is a block diagram illustrating components of an electronic device in accordance with one or more implementations of the subject technology.

FIG. 2 illustrates an example process for a compositing strokes on an underlying content item according to aspects of the subject technology.

FIG. 3 illustrates the capture of strokes according to aspects of the subject technology.

FIG. 4 illustrates the compositing of strokes on an underlying content item according to aspects of the subject technology.

FIG. 5 illustrates an example system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring concepts of the subject technology.

Drawing applications may allow a user to mark up an underlying content item using an implement such as a stylus (active or passive), a pointing device, or the user's finger to touch a screen displaying the content item. The implement may represent a user-selected tool having drawing properties including, but not limited to, color, shape, size, opacity, etc. The drawing properties of a tool also may include a blend mode used to composite a layer containing a stroke of the implement on the underlying content item. For example, a tool having a source-over blend mode would result in pixels of an underlying content item being replaced during composition by corresponding pixels from a stroke made using the implement. Alternatively, a tool having a multiply blend mode would result in the color values of pixels from a stroke made using the implement being multiplied by and replacing the color values of corresponding pixels in the underlying content item during composition. The subject technology is not limited to these two types of blend modes.

In a four-channel system, the layers containing the underlying content item and/or the strokes are represented using four components: RGBA (Red, Green, and Blue color values, Alpha opacity value). Layers having different blend modes may be composited with the underlying content item separately to preserve the desired blend mode appearance of the strokes on the content item. However, hundreds or even thousands of strokes may be made by a user on an underlying content item resulting in excessive time and processing requirements to composite all of the strokes on the underlying content item while maintaining the desired blend mode appearance of the strokes.

Processing requirements may be reduced by grouping all of the stroke layers into a single layer and compositing the grouped layer on the underlying content item. However, in a four-channel system each layer is composited using a single blend mode. Accordingly, the desired blend mode appearance of some of the stroke layers may be lost depending on the blend mode used to composite the grouped layer on the underlying content item.

The subject technology provides a multi-channel system to represent the stroke layers using components based on the color values and opacity value of the respective stroke as well as the blend mode associated with the stroke. A new blend mode is provided to combine the stroke layers into a single layer while maintaining the desired blend mode appearances of the different stroke layers. With the blend mode information being incorporated into the components representing the stroke layers, the new blend mode can be used to combine the stroke layers reducing the processing complexities required to combine the stroke layers. The single layer comprised of the different stroke layers is then composited on the underlying content item.

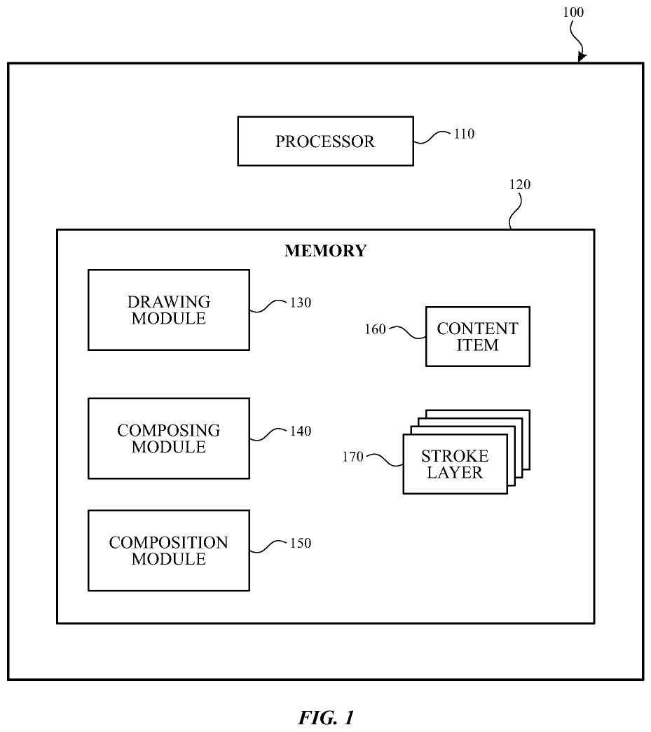

FIG. 1 is a block diagram illustrating components of an electronic device in accordance with one or more implementations of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

In the example depicted in FIG. 1, electronic device 100 includes processor 110 and memory 120. Processor 110 may include suitable logic, circuitry, and/or code that enable processing data and/or controlling operations of electronic device 100. In this regard, processor 110 may be enabled to provide control signals to various other components of electronic device 100. Processor 110 may also control transfers of data between various portions of electronic device 100. Additionally, the processor 110 may enable implementation of an operating system or otherwise execute code to manage operations of electronic device 100.

Processor 110 or one or more portions thereof, may be implemented in software (e.g., instructions, subroutines, code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

Memory 120 may include suitable logic, circuitry, and/or code that enable storage of various types of information such as received data, generated data, code, and/or configuration information. Memory 120 may include, for example, random access memory (RAM), read-only memory (ROM), flash memory, and/or magnetic storage. As depicted in FIG. 1, memory 120 contains drawing module 130, composing module 140, composition module 150, content item 160, and stroke layers 170. The subject technology is not limited to these components both in number and type, and may be implemented using more components or fewer components than are depicted in FIG. 1.

According to aspects of the subject technology, drawing module 130 comprises a computer program having one or more sequences of instructions or code together with associated data and settings. Upon executing the instructions or code, one or more processes are initiated to provide a drawing application on electronic device 100 for marking up and modifying the appearance of underlying content items such as web pages, screenshots, documents, etc. The drawing application may allow a user to select a particular drawing tool to be represented by the implement used by the user on a display of electronic device 100. The selected drawing tool may have associated properties such as size, shape, opacity, color, blend mode, etc. The drawing application may be configured to capture strokes made by the user using an implement on the screen of the electronic device based on points of contact between the implement and the screen and the properties of the selected tool. The drawing application may store each stroke in a respective stroke layer (e.g., stroke layers 170) for further processing.

According to aspects of the subject technology, composing module 140 comprises a computer program having one or more sequences of instructions or code together with associated data and settings. Upon executing the instructions or code, one or more processes are initiated to compose the strokes captured by the drawing application into the multi-channel system of the subject technology. For example, each pixel of a stroke captured by the drawing application may be represented with four channels: Red, Green, Blue, and Alpha (opacity) as well as an associated blend mode representing how the pixels of the stroke are to be composited on an underlying content item. Composing module 140 may be configured to select conversion formulas based on the associated blend mode of the stroke and convert the four-channel information into the multi-channel system of the subject technology having a group of additive color channels and a group of multiplicative mask channels that together represent both the color and opacity information of the stroke and the blend mode of the stroke. For example, the four-channel information and blend mode may be converted into three additive color channels (red, green, blue) and three multiplicative mask channels.

As noted above, the conversion formulas to convert the captured four-channel information into the multi-channel system of the subject technology is based on the blend mode of the stroke. According to aspects of the subject technology, formula (1) may be used to produce the additive color channels for a source over blend mode and formula (2) may be used to produce the multiplicative mask channels for the source over blend mode.

SrcOver_{color}=RGB·A (1)

SrcOverₘₐₛₖ=1−A (2)

Formula (3) may be used to produce the additive color channels for a multiply blend mode and formula (4) may be used to produce the multiplicative mask channels for the multiply blend mode.

Multiply_{color}=0 (3)

Muitiplyₘₐₛₖ=1−A+RGB·A (4)

Formula (5) may be used to produce the additive color channels for a screen blend mode and formula (6) may be used to produce the multiplicative mask channels for the screen blend mode.

Screen_{color}=1−RGB (5)

Screenₘₐₛₖ=1−RGB·A (6)

The source-over, multiply, and screen blend modes are known to those skilled in the art and will not be described in detail herein. The subject technology is not limited to these three blend modes and may be practiced with other blend modes.

In the multi-channel system of the subject technology, the blend mode space is a continuous space which allows for the creation of new blend modes by mixing existing blend modes. For example, the multiply and source over blend modes may be mixed to improve the behavior of the multiply blend mode in certain situations. In this regard, the multiply blend mode may be used to replicate a highlighter marker. However, repeated uses of the multiply blend mode over the same pixels may cause any of the color components having a value less than 1 to move towards black, which may not be aesthetically pleasing. This behavior can be remedied by mixing the multiply blend mode with the source over blend mode using a factor k representing the fraction that the color moves toward the final color with each application of the blend mode. Formula (7) may be used to produce the additive color channels for the mixed blend mode and formula (8) may be used to produce the multiplicative mask channels for the mixed blend mode.

MultiplyTowards_{color}=(1−(1−k)·RGB)·RGB·A (7)

MultiplyTowardsₘₐₛₖ=1−A+(1−k)·RGB·A (8)

In this example, if the factor k=1 the mix is equivalent to the source-over blend mode and if the factor k=0 the mix is equivalent to the multiply blend mode. The subject technology is not limited to the mix of these two blend modes and may be practiced mixing other blend modes.

According to aspects of the subject technology, composition module 150 comprises a computer program having one or more sequences of instructions or code together with associated data and settings. Upon executing the instructions or code, one or more processes are initiated to composite a source layer on a destination layer. In the multi-channel system of the subject technology, formula (9) may be used to composite the additive color channels and formula (10) may be used to composite the multiplicative mask channels.

result_{color}=src_{color}+dst_{color}·srcₘₐₛₖ (9)

resultₘₐₛₖ=srcₘₐₛₖ·dstₘₐₛₖ (10)

Using formulas (9) and (10), composition module 150 combines all of the stroke layers 170 into a single layer before compositing the single layer on the underlying content item 160 being modified by the strokes. The math involved in these formulas is associative (e.g., (AB)C=A(BC)). Accordingly, while the order of the stroke layers may be maintained in the order received by drawing module 130, the groupings in which they are combined into a single layer does not change the visual appearance of the final composition.

Because the same formulas (9) and (10) are used to composite or combine the stroke layers into a single layer, the processing can be optimized in software and/or hardware compared to using different formulas to composite and/or combine the strokes.

Composition module 150 is further configured to composite the single layer resulting from the combination of the stroke layers on an underlying content item. To composite the multi-channel (e.g., six channel) single layer from the stroke layers on the underlying content item having three RGB channels (dst_{color}), the single layer may be split into a color RGB layer (e.g., three channels) (src_{color}) having an additive blend mode and a mask RGB layer (e.g., three channels) (srcₘₐₛₖ) having a multiply blend mode. Formula (11) may be used to composite the split layers on the underlying content item.

result_{color}=src_{color}+dst_{color}·Srcₘₐₛₖ (11)

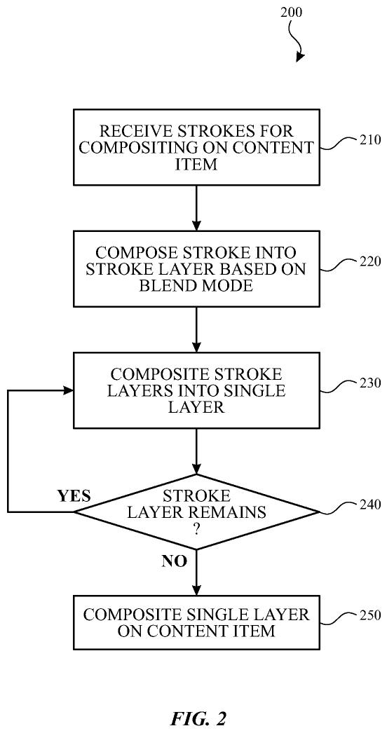

FIG. 2 illustrates an example process for compositing multiple strokes on an underlying content item according to aspects of the subject technology. For explanatory purposes, the blocks of process 200 are described herein as occurring in serial, or linearly. However, multiple blocks of process 200 may occur in parallel. In addition, the blocks of process 200 need not be performed in the order shown and/or one or more blocks of process 200 need not be performed and/or can be replaced by other operations.

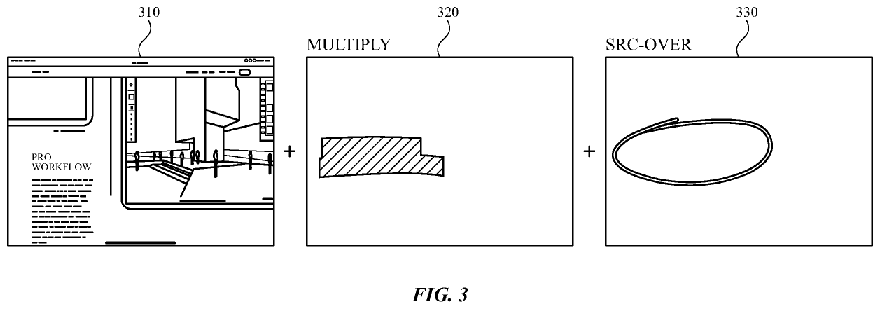

Process 200 begins upon receiving strokes made by a user with an implement on a screen displaying a content item (block 210). The individual strokes may be stored in a four-channel format (e.g., RGBA) and have an associated mode depending on the tool selected to be represented by the implement. FIG. 3 is a diagram illustrating the receipt of strokes for compositing on a content item. Referring to FIG. 3, content item 310 may be displayed by an electronic device and two strokes 320 and 330 may have been made by a user. In this example, stroke 320 corresponds to a marker stroke associated with a multiply blend mode. Stroke 330 corresponds to a pen stroke associated with a source-over blend mode.

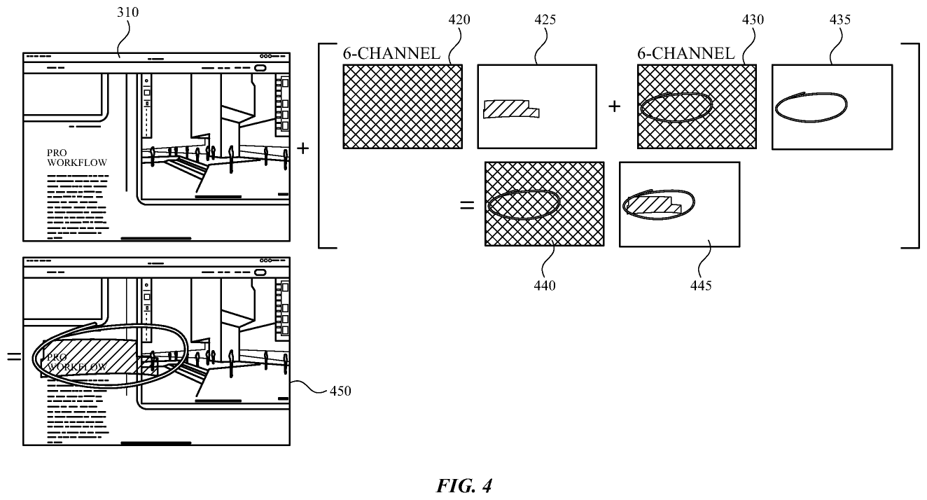

Returning to FIG. 2, process 200 continues with composing each stroke into a stroke layer in the multi-channel (e.g., six channel) format based on the associated blend mode (block 220). For example, stroke 320 depicted in FIG. 3 is associated with a multiply blend mode. Accordingly, stroke 320 is composed into a set of additive color channels using formula (3) above and a set of multiplicative mask channels using formula (4) above. Similarly, stroke 330 depicted in FIG. 3 is associated with a source-over blend mode. Accordingly, stroke 330 is composed into a set of additive color channels using formula (1) above and a set of multiplicative mask channels using formula (2) above. FIG. 4 is a diagram illustrating the composing and compositing process according to the current example. FIG. 4 depicts the set of additive color channels 420 and the set of multiplicative mask channels 425 composed from stroke 320. FIG. 4 also depicts the set of additive color channels 430 and the set of multiplicative mask channels 435 composed from stroke 330.

Process 200 continues by compositing the stroke layers into a single layer using formulas (9) and (10) above (block 230) until all of the stroke layers have been composited into the single layer (block 240). The composited single layer is depicted in FIG. 4 as the additive color channels 440 and the multiplicative mask channels 445. The composited single layer is then composited on the underlying content item 310 using formula (11) (block 250). The resulting composited content item is depicted in FIG. 4 as item 450. Item 450 may be provided for display by electronic device 100 showing the composited strokes on the underlying content item.

According to aspects of the subject technology, the six-channel system described above utilizes two 32-bit framebuffers rather than one 32-bit framebuffer, as used in four-channel systems. The additional bits (64 bits versus 32 bits) allow for 10 bits per color component to support wide gamut colors, 10 bits for each of the three additional channels, plus four additional bits to support special effects. For example, extra bits are available for a positive/negative sign to allow for blend modes that may require negative components. Extra bits also are available to support blend modes using components outside of the [0,1] range (e.g., >1).

The foregoing description has focused on compositing strokes on underlying content. The subject technology is not limited to the composition of strokes on underlying content and may be used to composite any type of content comprising image/pixel content on underlying content. For example, rather than a hand drawn stroke being composited on an underlying image, a first one or more digital images may be composited on a second digital image using the techniques described herein.

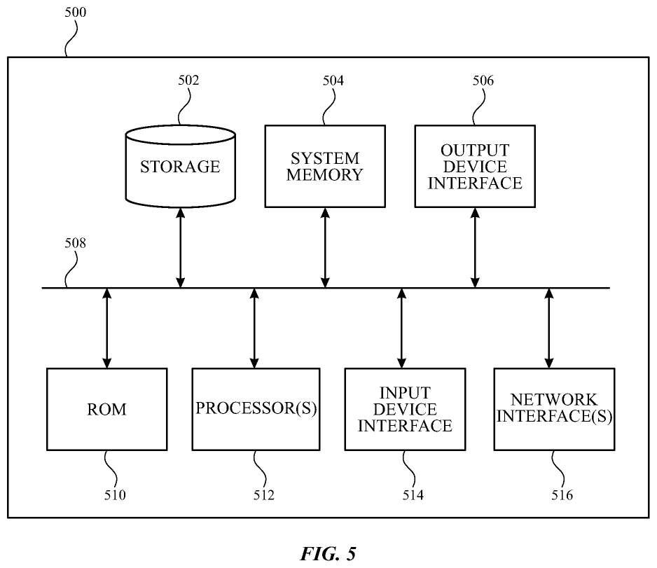

FIG. 5 illustrates an electronic system 500 with which one or more implementations of the subject technology may be implemented. Electronic system 500 can be, and/or can be a part of, electronic device 100 shown in FIG. 1. The electronic system 500 may include various types of computer readable media and interfaces for various other types of computer readable media. The electronic system 500 includes a bus 508, one or more processing unit(s) 512, a system memory 504 (and/or buffer), a ROM 510, a permanent storage device 502, an input device interface 514, an output device interface 506, and one or more network interfaces 516, or subsets and variations thereof.

The bus 508 collectively represents all system, peripheral, and chipset buses that communicatively connect the numerous internal devices of the electronic system 500. In one or more implementations, the bus 508 communicatively connects the one or more processing unit(s) 512 with the ROM 510, the system memory 504, and the permanent storage device 502. From these various memory units, the one or more processing unit(s) 512 retrieves instructions to execute and data to process in order to execute the processes of the subject disclosure. The one or more processing unit(s) 512 can be a single processor or a multi-core processor in different implementations.

The ROM 510 stores static data and instructions that are needed by the one or more processing unit(s) 512 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a floppy disk, flash drive, and its corresponding disk drive) may be used as the permanent storage device 502. Like the permanent storage device 502, the system memory 504 may be a read-and-write memory device. However, unlike the permanent storage device 502, the system memory 504 may be a volatile read-and-write memory, such as random access memory. The system memory 504 may store any of the instructions and data that one or more processing unit(s) 512 may need at runtime. In one or more implementations, the processes of the subject disclosure are stored in the system memory 504, the permanent storage device 502, and/or the ROM 510. From these various memory units, the one or more processing unit(s) 512 retrieves instructions to execute and data to process in order to execute the processes of one or more implementations.

The bus 508 also connects to the input and output device interfaces 514 and 506. The input device interface 514 enables a user to communicate information and select commands to the electronic system 500. Input devices that may be used with the input device interface 514 may include, for example, alphanumeric keyboards and pointing devices (also called “cursor control devices”). The output device interface 506 may enable, for example, the display of images generated by electronic system 500. Output devices that may be used with the output device interface 506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 508 also couples the electronic system 500 to one or more networks and/or to one or more network nodes through the one or more network interface(s) 516. In this manner, the electronic system 500 can be a part of a network of computers (such as a LAN, a wide area network (“WAN”), or an Intranet, or a network of networks, such as the Internet. Any or all components of the electronic system 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

According to aspects of the subject technology, a method is provided that includes receiving a plurality of strokes for compositing on a content item and composing each stroke of the plurality of strokes into a respective stroke layer based on a blend mode associated with the respective stroke. The method further includes compositing the stroke layers composed from the plurality of strokes into a single layer and compositing the single layer on the content item.

Composing each stroke of the plurality of strokes into a respective stroke layer may include converting each stroke represented by a first plurality of channels into a respective stroke layer represented by a second plurality of channels different from the first plurality of channels. The first plurality of channels may consist of four channels and the second plurality of channels may consist of six channels. The second plurality of channels may consist of three additive color channels and three multiplicative mask channels.

At least one stroke of the plurality of strokes may be associated with a different blend mode than at least one other stroke of the plurality of strokes. The plurality of strokes may be composited into a single layer using a first blend mode. The single layer may be composited on the content item using a second blend mode. The first blend mode may be different from the second blend mode. The single layer has a third plurality of channels and the content item has a fourth plurality of channels different from the third plurality of channels. The third plurality of channels may consist of six channels and the fourth plurality of channels consists of four channels.

According to aspects of the subject technology, a non-transitory computer-readable medium storing instructions which, when executed by one or more processors, cause the one or more processors to perform operations is provided. The operations include receiving a plurality of strokes for compositing on a content item and composing each stroke of the plurality of strokes into a respective stroke layer by converting each stroke represented by a first plurality of channels into a respective stroke layer represented by a second plurality of channels different from the first plurality of channels based on a blend mode associated with the respective stroke. The operations further include compositing the stroke layers composed from the plurality of strokes into a single layer and compositing the single layer on the content item.

The first plurality of channels may consist of four channels and the second plurality of channels consists of three additive color channels and three multiplicative mask channels. At least one stroke of the plurality of strokes may be associated with a different blend mode than at least one other stroke of the plurality of strokes. The plurality of strokes may be composited into a single layer using a first blend mode, and the single layer may be composited on the content item using a second blend mode. The first blend mode may be different from the second blend mode.

According to aspects of the subject technology, a device is provided that includes a memory storing a plurality of computer programs, and one or more processors configured to execute instructions of the plurality of computer programs. The instructions include instructions to receive a plurality of strokes for compositing on a content item and to compose each stroke of the plurality of strokes into a respective stroke layer based on a blend mode associated with the respective stroke, wherein at least one stroke of the plurality of strokes is associated with a different blend mode than at least one other stroke of the plurality of strokes. The instructions further include instructions to composite the stroke layers composed from the plurality of strokes into a single layer and to composite the single layer on the content item.

Composing each stroke of the plurality of strokes into a respective stroke layer may include converting each stroke represented by a first plurality of channels into a respective stroke layer represented by a second plurality of channels different from the first plurality of channels. The first plurality of channels may consist of four channels and the second plurality of channels may consist of three additive color channels and three multiplicative mask channels. The plurality of strokes may be composited into a single layer using a first blend mode, and the single layer may be composited on the content item using a second blend mode. The first blend mode may be different from the second blend mode.

As described herein, aspects of the subject technology may include the collection and transfer of data from an application. The present disclosure contemplates that in some instances, this collected data may include personal information data that uniquely identifies or can be used to identify a specific person. Such personal information data can include demographic data, location-based data, online identifiers, telephone numbers, email addresses, home addresses, images, data or records relating to a user's health or level of fitness (e.g., vital signs measurements, medication information, exercise information), date of birth, or any other personal information.

The present disclosure recognizes that the use of such personal information data, in the present technology, can be used to the benefit of users. Various uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of video conferencing, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
receiving a plurality of strokes for compositing on a content item;
composing each stroke of the plurality of strokes into a respective stroke layer based on a blend mode associated with the respective stroke;
compositing the stroke layers composed from the plurality of strokes into a single layer; and
compositing the single layer on the content item.

2. The method of claim 1, wherein composing each stroke of the plurality of strokes into a respective stroke layer comprises converting each stroke represented by a first plurality of channels into a respective stroke layer represented by a second plurality of channels different from the first plurality of channels.

3. The method of claim 2, wherein the first plurality of channels consists of four channels and the second plurality of channels consists of six channels.

4. The method of claim 3, wherein the second plurality of channels consists of three additive color channels and three multiplicative mask channels.

5. The method of claim 1, wherein at least one stroke of the plurality of strokes is associated with a different blend mode than at least one other stroke of the plurality of strokes.

6. The method of claim 1, wherein the plurality of strokes are composited into a single layer using a first blend mode.

7. The method of claim 6, wherein the single layer is composited on the content item using a second blend mode.

8. The method of claim 7, wherein the first blend mode is different from the second blend mode.

9. The method of claim 1, wherein the single layer has a third plurality of channels and the content item has a fourth plurality of channels different from the third plurality of channels.

10. The method of claim 9, wherein the third plurality of channels consists of six channels and the fourth plurality of channels consists of four channels.

11. A non-transitory computer-readable medium storing instructions which, when executed by one or more processors, cause the one or more processors to perform operations comprising:
receiving a plurality of strokes for compositing on a content item;
composing each stroke of the plurality of strokes into a respective stroke layer by converting each stroke represented by a first plurality of channels into a respective stroke layer represented by a second plurality of channels different from the first plurality of channels based on a blend mode associated with the respective stroke;
compositing the stroke layers composed from the plurality of strokes into a single layer; and
compositing the single layer on the content item.

12. The non-transitory computer-readable medium of claim 11, wherein the first plurality of channels consists of four channels and the second plurality of channels consists of three additive color channels and three multiplicative mask channels.

13. The non-transitory computer-readable medium of claim 11, wherein at least one stroke of the plurality of strokes is associated with a different blend mode than at least one other stroke of the plurality of strokes.

14. The non-transitory computer-readable medium of claim 11, wherein the plurality of strokes are composited into a single layer using a first blend mode, and
wherein the single layer is composited on the content item using a second blend mode.

15. The non-transitory computer-readable medium of claim 14, wherein the first blend mode is different from the second blend mode.

16. A device, comprising:
a memory storing:
a plurality of computer programs; and
one or more processors configured to execute instructions of the plurality of computer programs to:
receive a plurality of strokes for compositing on a content item;
compose each stroke of the plurality of strokes into a respective stroke layer based on a blend mode associated with the respective stroke, wherein at least one stroke of the plurality of strokes is associated with a different blend mode than at least one other stroke of the plurality of strokes;
composite the stroke layers composed from the plurality of strokes into a single layer; and
composite the single layer on the content item.

17. The device of claim 16, wherein composing each stroke of the plurality of strokes into a respective stroke layer comprises converting each stroke represented by a first plurality of channels into a respective stroke layer represented by a second plurality of channels different from the first plurality of channels.

18. The device of claim 17, wherein the first plurality of channels consists of four channels and the second plurality of channels consists of three additive color channels and three multiplicative mask channels.

19. The device of claim 16, wherein the plurality of strokes are composited into a single layer using a first blend mode, and
wherein the single layer is composited on the content item using a second blend mode.

20. The device of claim 19, wherein the first blend mode is different from the second blend mode.
